(19) United States
(12) Patent Application Publication
(10) Pub. No.: US 2024/0386070 A1
(43) Pub. Date: Nov. 21, 2024

(54) CHILD PROBLEM GENERATION DEVICE AND CHILD PROBLEM GENERATION METHOD

(71) Applicant: NEC Corporation, Minato-ku, Tokyo (JP)

(72) Inventor: Fumiyo TAKANO, Tokyo (JP)

(73) Assignee: NEC Corporation, Minato-ku, Tokyo (JP)

(21) Appl. No.: 18/688,866

(22) PCT Filed: Sep. 21, 2021
(86) PCT No.: PCT/JP2021/034585

§ 371 Date: Mar. 4, 2024

(51) Int. Cl. G06F 17/11

(52) U.S. Cl. CPC G06F 17/11

(57) ABSTRACT

Provided is a child problem generation device that can generate a child problem in such a way as to prevent as much as possible the narrowing of the search range for the solution of the child problem when constraints are defined on sets of spins. The first selection means 71 selects one spin to be added to a child problem of a combinatorial optimization problem from each spin in the combinatorial optimization problem, and adds the one spin to the child problem. When any of spins in the child problem belong to a set for which a constraint is defined, the second selection means 72 selects the set, selects each spin that belongs to the set and has not been added to the child problem, and adds each spin to the child problem.

### TECHNICAL FIELD

The present invention relates to a child problem generation device, a child problem generation method, and a child problem generation program for generating a child problem of combinatorial optimization problem.

### BACKGROUND ART

Research is underway on techniques for solving combinatorial optimization problems. Examples of the combinatorial optimization problems include the traveling salesman problem, the knapsack problem, and the graph partitioning problem. However, the combinatorial optimization problems are not limited to these problems.

The Ising model is a model in statistical mechanics that represents the behavior of a magnetic material by individual spins, and it is also applicable to solving the combinatorial optimization problems. In the Ising model, the states of individual spins are represented by “1” or “−1”.

QUBO (Quadratic Unconstrained Binary Optimization) is also known as a model in which the states of individual spins are represented by “1” or “0”.

“1” in the Ising model and “1” in QUBO can be referred to as the first value. “−1” in the Ising model and “0” in QUBO can be referred to as the second value.

The energy function of the Ising model and the energy function of QUBO are mutually convertible.

In general, when solving a combinatorial optimization problem, an expression representing energy in the combinatorial optimization problem is converted to the energy function of the Ising model or the energy function of QUBO. Then, using the energy function, the solution to the combinatorial optimization problem is found, for example, by simulated annealing. The method of converting the expression representing the energy in the combinatorial optimization problem into the energy function of the Ising model or QUBO is known.

The energy function of the Ising model is expressed as in Expression (1) below.

$$\begin{matrix}[ Math . 1 ] & \\ {H}_{Ising} = {\sum }_{ij} {J}_{ij} {s}_{i} {s}_{j} + {\sum }_{i} {h}_{i} {s}_{i} & ( 1 )\end{matrix}$$

sᵢ, sⱼ in Expression (1) are variables that represent a state of a spin. The subscripts in these variables identify the spins. jᵢⱼ is a constant corresponding to i and j, and hᵢ is a constant corresponding to i.

The energy function of QUBO is expressed as in Expression (2) below.

$$\begin{matrix}[ Math . 2 ] & \\ {H}_{QUBO} = {\sum }_{ij} {Q}_{ij} {x}_{i} {x}_{j} & ( 2 )\end{matrix}$$

xᵢ, xⱼ in Expression (2) are variables that represent a state of a spin. The subscripts in these variables identify the spins. Qᵢⱼ is a constant corresponding to i and j.

When solving a combinatorial optimization problem, selecting some of the spins among the multiple spins in the combinatorial optimization problem is called generating a child problem. Some of the selected spins are called a child problem.

An example of a method for finding a solution to a combinatorial optimization problem while generating a child problem is described, for example, in NPL 1 and 2. An example of the solution method described in NPL 2 is shown below. FIG. 8 is a flowchart showing a schematic of an example of the solution method described in NPL 2. The following description assumes that a computer performs the processing. In this example, it is assumed that the computer is given the energy function of QUBO according to the combinatorial optimization problem.

The computer finds a tentative solution to the combinatorial optimization problem (step S101). NPL 2 describes the use of TABU search to find the tentative solution.

Next, the computer sorts the spins in descending order based on the impact value of each spin (step S102). The impact value is an amount of increase in the energy function when the state of a spin is flipped.

Next, the computer selects the top 5-15% spins after sorting and defines the spins a child problem (step S103).

The computer then finds the solution to the child problem (step S104). To find the solution to the child problem, the states of the spins not included in the child problem are fixed at the states of the tentative solution, and the state of each spin included in the child problem can be found, for example, by simulated annealing.

Next, the computer updates the tentative solution using the solution to the child problem and finds the tentative solution again, for example, by the TABU search (step S105).

The computer determines whether the termination condition has been met or not (step S106). If the termination condition is met (Yes in step S106), the process is terminated. If the termination condition is not met (No in step S106), the process is repeated from step S102 onward.

In the above example, a child problem is generated with a tentative solution found, and the solution to the child problem is found.

### CITATION LIST

### Non Patent Literature

NPL 1: Michael Booth, Steven P. Reinhardt, and Aidan Roy, “Partitioning Optimization Problems for Hybrid Classical/Quantum Execution”, D-Wave Technical Report Series, Jan. 9, 2017.

NPL 2: “Qbsolv problem-splitting algorithm study”, [online], Jan. 7, 2019, [retrieved on Jul. 16 2021], Internet<URL:

https://quantum.fixstars.com/techresources/research/qbsolv/>

### SUMMARY OF INVENTION

### Technical Problem

In a combinatorial optimization problem, sets of spins and constraints to be satisfied by each set may be predefined. In this case, for example, multiple sets of spins are defined, and a constraint is defined for each set.

Various examples of constraints defined for sets of spins are described below. The following is an example of QUBO.
(1) An example of a constraint on a set of spins is a constraint that only one of the spins in the set is set to “1” and all other spins in the set are set to “0. This constraint is hereafter referred to as “the first constraint”. The first constraint is sometimes referred to as the one-hot constraint.
(2) Another example of a constraint on a set of spins is a constraint that at least one of the multiple spins in the set is set to “0”. This constraint is hereafter referred to as “the second constraint”.
(3) Another example of a constraint on a set of spins is a constraint that at least one of the multiple spins in the set is set to “1”. This constraint is hereafter referred to as “the third constraint”.

Constraints are not limited to only the above constraints shown in the examples.

In the above-mentioned solution method described in NPL 2, the top 5 to 15% spins are selected in order of increasing impact value, and the selected spins are used as a child problem. In this method of generating child problem, it can happen that spins belonging to a set with a defined constraint are divided into spins that are included in the child problem and spins that are not included in the child problem. For example, even if a constraint is defined in advance for the set of spins x₁, x₂, x₃, and x₄, it can happen that only the spins x₃ and x₄ are included in the child problem and the spins x₁ and x₂ are not included in the child problem. Then, when finding a solution to the child problem, the solution search range will be narrowed.

FIG. 9 is a schematic diagram showing an example of a narrower solution search range. In FIG. 9, the values shown in parentheses are the tentative solution values. This is also the case in FIG. 10 below. In the example shown in FIG. 9, it is assumed that the aforementioned second constraint is defined for the set of spins x₁, x₂. Further, it is assumed that the spins x₂, x₃, x₄, etc. are selected as a child problem, but the spin x₁ is not included in the child problem. When finding a solution to the child problem, the state of the spins not included in the child problem is fixed to the state of the tentative solution. That is, the value of x₁ is fixed to 1. Therefore, in the case illustrated in FIG. 9, the cases {x₁=0, x₂=0} and {x₁=0, x₂=1} will not be searched when finding the solution to the child problem, and the search range will be narrowed.

FIG. 10 is a schematic diagram showing another example of a narrower solution search range. In the example shown in FIG. 10, it is assumed that the aforementioned first constraint (the one-hot constraint) is defined for the set of spins x₁, x₂, x₃, x₄. Further, it is assumed that the spins x3, x4, x5, x6, etc. are selected as a child problem, but the spins x₁, x₂ are not included in the child problem. When finding a solution to the child problem, the values of the spins x₁, x₂ are both fixed to 0 (the tentative solution of x₁, x₂). Thus, in the case illustrated in FIG. 10, when finding the solution to the child problem, the cases {x₁=0, x₂=0, x₃=0, x₄=1} and {x₁=0, x₂=0, x₃=1, x₄=0} are searched, but the cases {x₁=1, x₂=0, x₃=0, x₄=0} and {x1=0, x₂=1, x₃=0, x₄4=0} will not be searched and the search range will be narrowed.

Therefore, the purpose of the present invention is to provide a child problem generation device, a child problem generation method, and a child problem generation program that can generate a child problem in such a way as to prevent as much as possible the narrowing of the search range for the solution of the child problem when constraints are defined on sets of spins.

### Solution to Problem

A child problem generation device according to the present invention includes: first selection means for selecting one spin to be added to a child problem of a combinatorial optimization problem from each spin in the combinatorial optimization problem, and adding the one spin to the child problem; and second selection means for, when any of spins in the child problem belong to a set for which a constraint is defined, selecting the set, selecting each spin that belongs to the set and has not been added to the child problem, and adding each spin to the child problem.

A child problem generation method according to the present invention is implemented by a computer and includes: selecting one spin to be added to a child problem of a combinatorial optimization problem from each spin in the combinatorial optimization problem, and adding the one spin to the child problem; and when any of spins in the child problem belong to a set for which a constraint is defined, selecting the set, selecting each spin that belongs to the set and has not been added to the child problem, and adding each spin to the child problem.

A child problem generation program according to the present invention causes a computer to execute: a first selection process of selecting one spin to be added to a child problem of a combinatorial optimization problem from each spin in the combinatorial optimization problem, and adding the one spin to the child problem; and a second selection process of, when any of spins in the child problem belong to a set for which a constraint is defined, selecting the set, selecting each spin that belongs to the set and has not been added to the child problem, and adding each spin to the child problem. The present invention may be a computer-readable recording medium in which the child problem generation program is recorded.

### Advantageous Effects of Invention

According to the present invention, it is possible to generate a child problem in such a way as to prevent as much as possible the narrowing of the search range for the solution of the child problem when constraints are defined on sets of spins.

### BRIEF DESCRIPTION TO DRAWING

FIG. 1 It depicts a block diagram showing a configuration example of a child problem generation device of an example embodiment of the present invention.

FIG. 2 It depicts a flowchart showing an example of the processing flow of the example embodiment of the present invention.

FIG. 3 It depicts a schematic diagram showing an example of sets of spins with a defined constraint.

FIG. 4 It depicts a schematic diagram showing an example of sets of spins with a defined constraint.

FIG. 5 It depicts a flowchart showing an example of the processing flow in one of the variations of the example embodiment of the present invention.

FIG. 6 It depicts a schematic block diagram showing an example of a computer configuration of the child problem generation device of the example embodiment or variations thereof of the present invention.

FIG. 7 It depicts a block diagram showing an overview of the child problem generation device of the present invention.

FIG. 8 It depicts a flowchart showing a schematic of an example of the solution method described in NPL 2.

FIG. 9 It depicts a schematic diagram showing an example of a narrower solution search range.

FIG. 10 It depicts a schematic diagram showing another example of a narrower solution search range.

### DESCRIPTION OF EMBODIMENTS

An example embodiment of the present invention is described below with reference to the drawings.

In the following example embodiment of the present invention and variations thereof, it is assumed that a tentative solution for each spin of a combinatorial optimization problem is predetermined. The method of determining the tentative solution is not limited.

It is assumed that the energy function of the combinatorial optimization problem (the energy function of the Ising model or QUBO) is determined in advance.

It is also assumed that each set of spins and the constraints that each set must satisfy are predefined. For example, multiple sets of spins are defined, and a constraint is defined for each set.

Each set of spins and the constraints to be satisfied by each set may be set, for example, by a user of a child problem generation device of the present example embodiment. However, the setting of each set of spins and the constraints to be satisfied by each set of spins are not limited to the above examples.

A single spin may belong to multiple sets.

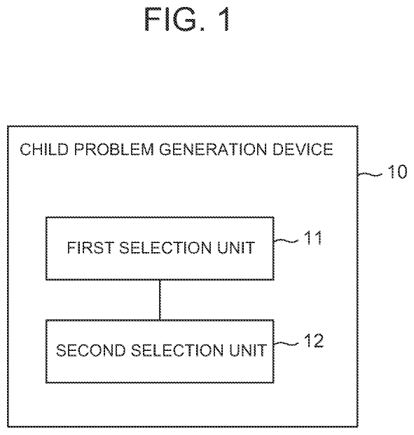

FIG. 1 is a block diagram showing a configuration example of a child problem generation device of an example embodiment of the present invention. The child problem generation device 10 of the present example embodiment includes a first selection unit 11 and a second selection unit 12.

The first selection unit 11 selects one spin to be added to the child problem from each spin in the combinatorial optimization problem and adds the one spin to the child problem. In the present example embodiment, the first selection unit 11 randomly selects the one spin and adds the one spin to the child problem.

The second selection unit 12 is given, in advance, information representing each set of spins and the constraints to be satisfied by each set.

Then, when any of the spins in the child problem belong to a set for which the constraint is defined, the second selection unit 12 selects the set. Furthermore, the second selection unit 12 selects each spin that belongs to the set and has not been added to the child problem, and adds each spin to the child problem.

The first selection unit 11 and the second selection unit 12 are realized, for example, by a CPU (Central Processing Unit) of a computer operating according to a child problem generation program. In this case, the CPU may read the child problem generation program from a program storage medium such as a program storage device of the computer, and operate as the first selection unit 11 and the second selection unit 12 according to the child problem generation program.

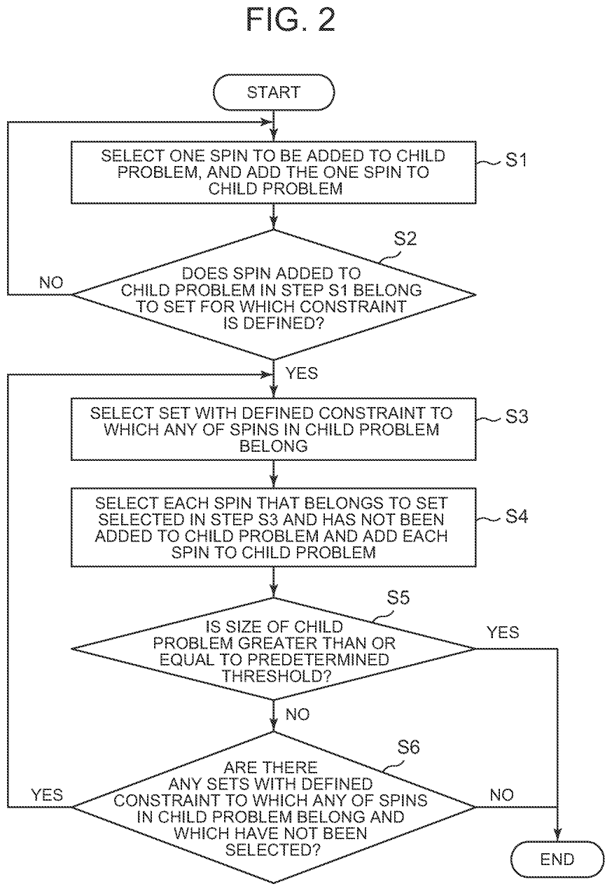

Next, the processing flow is described. FIG. 2 is a flowchart showing an example of the processing flow of the example embodiment of the present invention. It is assumed that the second selection unit 12 has already been given information representing each set of spins and the constraints to be satisfied by each set.

The first selection unit 11 selects one spin to be added to the child problem from each spin of the combinatorial optimization problem and adds the one spin to the child problem (step S1). In the present example embodiment, in step S1, the first selection unit 11 randomly selects the one spin to be added to the child problem.

The second selection unit 12 determines whether or not the spin added to the child problem in step Sl belongs to a set for which a constraint is defined (step S2). When the spin added to the child problem in step SI does not belong to the set for which the constraint is defined (No in step S2), the operation from step S1 onward is repeated.

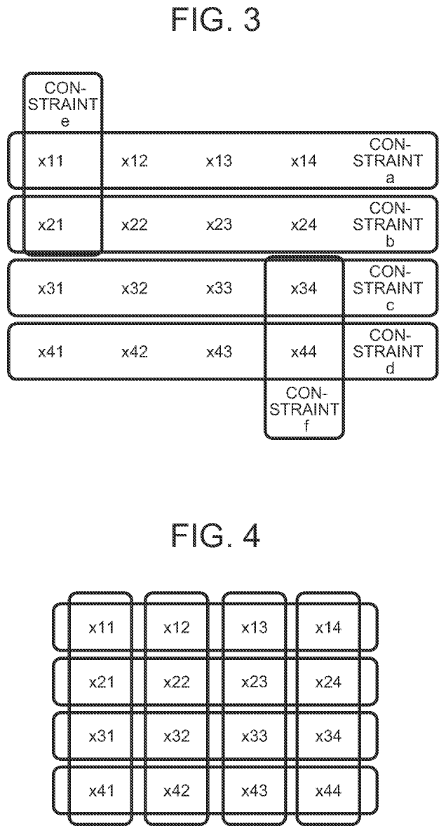

When the spin added to the child problem in step SI belong to the set for which the constraint is defined (Yes in step S2), move to step S3. The following is an explanation with specific examples. FIG. 3 is a schematic diagram showing an example of sets of spins with a defined constraint. In the example shown in FIG. 3, the total number of spins is 16. The sets of spins for which a constraint is defined are shown with a frame around them. For example, the set of spins x₁₁, x₁₂, x₁₃, and x₁₄ is a set for which constraint a is defined. In the example shown in FIG. 3, there are no spins that do not belong to a set for which a constraint is defined. Therefore, the spin added to the child problem in step S1 is not determined to not belong to the set for which the constraint is defined, and the process moves from step S2 to step S3.

In this example, the case where the one spin added to the child problem in step S1 is the spin x₁₁ is used.

In step S3, the second selection unit 12 selects a set with a defined constraint to which any of the spins in the child problem belong. In the second and subsequent step S3, the second selection unit 12 excludes from the selection target the sets that have already been selected. That is, the second selection unit 12 selects the set with a defined constraint to which any of the spins in the child problem belong and which have not yet been selected.

In this example, at the time of the first transition to step S3, the only spin included in the child problem is spin x₁₁. In addition, there are the set with constraint a and the set with constraint e as sets with a defined constraint that the spin x₁₁ belongs to (see FIG. 3). In other words, there are multiple sets that can be selected at this point. In the present example embodiment, when there are multiple selectable sets, the second selection unit 12 may randomly select a set from among the sets. In this example, the second selection unit 12 is described as selecting the set with constraint a from the set with constraint a and the set with constraint e.

Next to step S3, the second selection unit 12 selects each spin that belongs to the set selected in step S3 and has not been added to the child problem and adds each spin to the child problem (step S4). The spins in the set with constraint a selected in step S3 that have not been added to the child problem are the spins x₁₂, x₁₃, and x₁₄. Therefore, in this case, in step S4, the second selection unit 12 adds the spins x₁₂, x₁₃, and x₁₄ to the child problem. As a result, the child problem include x₁₁, x₁₂, x₁₃, and x₁₄. Next, the second selection unit 12 determines whether or not the size of the child problem is greater than or equal to a predetermined threshold (step S5). The size of the child problem is, for example, the number of spins in the child problem. The upper limit of the size of the child problem for which a solution to the child problem can be found without running out of memory or other resources can be predetermined as the threshold. When the size of the child problem is greater than or equal to the threshold (Yes in step S5), it is assumed that the child problem cannot be solved and the process is terminated at that point. In this example, it is assumed that the size of the child problem is less than the threshold. When the size of the child problem is less than the threshold (No in step S5), the process moves to step S6.

In step S6, the second selection unit 12 determines whether or not there are any sets with a defined constraint to which any of the spins in the child problem belong and which have not been selected in step S3. When there is no such set (No in step S6), the process ends at that point. When there is such a set (Yes in step S6), the process is repeated from step S3 onward. In this example, at the time of the first transition to step 6, the child problem includes the spins x₁₁, x₁₂, x₁₃, x₁₄. The spins x₁₂, x₁₃, and x₁₄ belong only to the set with constraint a, and the set with constraint a has already been selected. The spin x₁₁ belongs to the set with constraint a and the set with constraint e, and the set with constraint e has not yet been selected (Yes in step S6). Therefore, the process is repeated from step S3 onwards.

In the second step S3, the second selection unit 12 selects the set with constraint e to which the spin x₁₁ belongs and which has not yet been selected.

In the next step S4, the second selection unit 12 selects a spin x₂₁ (see FIG. 3) that belongs to the set with constraint e and has not been added to the child problem, and adds the spin x₂₁ to the child problem. As a result, the child problem includes x₁₁, x₁₂, x₁₃, x₁₄, and x₂₁.

Then, it is assumed that the size of the child problem is still less than the threshold (No in step S5).

At the second transition to step S6, the child problem includes x₁₁, x₁₂, x₁₃, x₁₄, and x₂₁. The spins x₁₂, x₁₃, and x₁₄ belong only to the set with constraint a, and the set with constraint a has already been selected. The spin x₁₁ belongs to the set with constraint a and the set with constraint e, both of which have already been selected. The spin x₂₁ belongs to the set with constraint e and the set with constraint b, and the set with constraint b has not yet been selected (Yes in step S6). Therefore, the process is repeated from step S3 onwards.

In the third step S3, the second selection unit 12 selects the set with constraint b to which the spin x₂₁ belongs and which has not yet been selected.

In the next step S4, the second selection unit 12 selects each spin x₂₂, x₂₃, x₂₄ (see FIG. 3) that belongs to the set with constraint b and has not been added to the child problem and adds each spin x₂₂, x₂₃, x₂₄ to the child problem. As a result, the child problem includes x₁₁, x₁₂, x₁₃, x₁₄, x₂₁, x₂₂, x₂₃, x₂₄.

Then, it is assumed that the size of the child problem is still less than the threshold (No in step S5).

At the third transition to step S6, the child problem includes x₁₁, x₁₂, x₁₃, x₁₄, x₂₁, x₂₂, x₂₃, and x₂₄. The spins x₁₂, x₁₃, and x₁₄ belong only to the set with constraint a, and the set with constraint a has been selected. The spin xu belongs to the set with constraint a and the set with constraints e, both of which have already been selected. The spin x₂₁ belongs to the set with constraints e and the set with constraint b, both of which have already been selected. The spins x₂₂, x₂₃, and x₂₄ belong only to the set with constraint b, and the set with constraint b has already been selected. Therefore, the second selection unit 12 determines that there are no sets with a defined constraint to which any of the spins in the child problem belong and which have not been selected in step S3 (No in step S6) and terminates the process. As a result, in this example, the spins x₁₁, x₁₂, x₁₃, x₁₄, x₂₁, x₂₂, x₂₃, and x₂₄ are the child problem. In addition, the spins x₃₁, x₃₂, x₃₃, x₃₄, x₄₁, x₄₂, x₄₃, and x₄₄ shown in FIG. 3 are not included in the child problem.

When solving the child problem generated by the child problem generation device of the present example embodiment, the state of the spins not included in the child problem can be fixed to the state of the tentative solution, and the solution to the generated child problem can be found using the energy function, for example, by simulated annealing. In the above example, the states of the spins x₃₁, x₃₂, x₃₃, x₃₄, x₄₁, x₄₂, x₄₃, x₄₄ can be fixed to the state of the tentative solution, and the state of each spin x₁₁, x₁₂, x₁₃, x₁₄, x₂₁, x₂₂, x₂₃, x₄ corresponding to the child problem can be found by simulated annealing, for example. However, the method of finding the solution to the child problem is not limited to the above example.

According to the present example embodiment, when any of the spins included in the child problem belong to the set for which a constraint is defined, the second selection unit 12 selects the set, selects each spin that belongs to the set and has not been added to the child problem, and adds each spin to the child problem. Thus, when the size of the child problem is less than the threshold, it can prevent the spins belonging to the set for which a constraint is defined from being divided into spins that are included in the child problem and spins that are not included in the child problem. Therefore, it is possible to generate a child problem in such a way as to prevent as much as possible the narrowing of the search range for the solution of the child problem.

Next, variations of the example embodiment of the present invention will be described.

In the above example embodiment, the first selection unit 11 randomly selects one spin in step S1 (see FIG. 2) and adds the one spin to the child problem. The first selection unit 11 may select one spin in other ways.

For example, in step S1, the first selection unit 11 calculates, for each individual spin in the combinatorial optimization problem, an amount of increase in the energy function of the combinatorial optimization problem when the state of spin is flipped. The first selection unit 11 may then select one spin with the largest increase and add the one spin to the child problem. When it is determined in step S2 that the spin does not belong to the set for which a constraint is defined (No in step S2) and the process moves to step S1 again, the first selection unit 11 may select the one spin among the unselected spins that has the largest increase in the above amount and add the one spin to the child problem. The amount of increase in the energy function of the combinatorial optimization problem when the state of spin is flipped corresponds to the impact value described in NPL 2, and will be hereinafter referred to as the impact value.

In step S1, the first selection unit 11 may also select one spin that belongs to a set for which a constraint is defined and for which the constraint is not satisfied, and add the one spin to the child problem. In this variation, the first selection unit 11 is given, in advance, information representing each set of spins and the constraints to be satisfied by each set. When selecting one spin belonging to a set for which a constraint is defined and for which the constraint is not satisfied, the first selection unit 11 may randomly select one spin from among the spins belonging to the set. Alternatively, the first selection unit 11 may select the spin with the largest impact value among the spins belonging to the set.

The following example is illustrated with reference to FIG. 3. For example, it is assumed that constraint a is satisfied in the set with constraint a shown in FIG. 3, constraint b is satisfied in the set with constraint b, constraint c is satisfied in the set with constraint c, and constraint d is satisfied in the set with constraint d. Also, in the set with constraint e, constraint e is not satisfied, and in the set with constraint f, constraint f is not satisfied. In this case, in step S1, the first selection unit 11 may, for example, randomly select one spin from the spins belonging to the set with constraint e and the spins belonging to the set with constraint f, and add the one spin to the child problem. In the above example, the case where there are multiple sets with a constraint that is not satisfied is shown, but when there is only one set with a constraint that is not satisfied, the first selection unit 11 may only select one spin from the one set.

The priority of the constraints may be predetermined. Then, in step S1, the first selection unit 11 may select one spin that belongs to the set with a constraint with the highest priority defined, and add the one spin to the child problem. In this variation, too, the first selection unit 11 is given, in advance, information representing each set of spins and the constraints to be satisfied by each set. Information indicating the priority of the constraints is also given to the first selection unit 11 in advance. The priority of the constraints can be predetermined, for example, by the user of the child problem generation device 10.

A specific example is described below with reference to FIG. 3. In this example, it is assumed that the first constraint (the one-hot constraint) has the highest priority, the second constraint has the second highest priority, and the third constraint has the third highest priority. Also, it is assumed that constraint e and constraint f shown in FIG. 3 are the first constraint, constraint a and constraint c are the second constraint, and constraint b and constraint d are the third constraint. In this case, constraint e and constraint f are the first constraint with the highest priority. Therefore, in step S1, the first selection unit 11 may, for example, randomly select one spin from the spins that belong to the set with constraints e and the spins that belong to the set with constraints f, and add the one spin to the child problem. The above example shows the case where there are multiple sets with constraints with the highest priority, but when there is only one set with a constraint with the highest priority, the first selection unit 11 may only select one spin from the one set.

As in the above variation, the priority of the constraints may be predetermined. Then, in step S3, when there are multiple sets to which any of the spins in the child problem belong and for which a constraint is defined, the second selection unit 12 may select the set with the highest priority among the multiple sets. In this case, information representing each set of spins and the constraints to be satisfied by each set as well as information indicating the priority of the constraints are given to the second selection unit 12 in advance. As mentioned above, the priority of the constraints may be predetermined, for example, by the user of the child problem generation device 10.

The following example is illustrated with reference to FIG. 3. As in the previous example, it is assumed that the first constraint (the one-hot constraint) has the highest priority, the second constraint has the second highest priority, and the third constraint has the third highest priority, as previously defined. Also, it is assumed that constraint e and constraint f shown in FIG. 3 are the first constraint, constraint a and constraint c are the second constraint, and constraint b and constraint d are the third constraint. It is assumed that in step S1, the spin x₁₁ is selected and the spin x₁₁ is added to the child problem, the process moved to step S3. There are a set with constraint a and a set with constraint e as sets with a constraint that the spin x₁₁ belongs to (see FIG. 3). Here, constraint e has the highest priority among constraint a (the second constraint) and e (the first constraint). Therefore, in this case, in step S3, the second selection unit 12 selects the set with constraint e. Then, in the next step S4, the second selection unit 12 selects the spin x₂₁ that belongs to the set with constraint e and has not been added to the child problem, and adds the spin x₂₁ to the child problem.

Next, at the time of moving to step S3, there is a set with constraint a to which spin x₁₁ belongs and which have not yet been selected and a set with constraint b to which spin x₂₁ belongs and which have not yet been selected. Here, constraint a has the highest priority among constraint a (the second constraint) and constraint b (the third constraint). Therefore, the second selection unit 12 selects the set with constraint a. Then, in the next step S4, the second selection unit 12 selects each spin x₁₂, x₁₃, x₁₄ that belongs to the set with constraint a and has not been added to the child problem, and adds each spin x₁₂, x₁₃, x₁₄ to the child problem.

Next, at the time of moving to step S3, there is a set with constraint b to which the spin x₂₁ belongs and which has not yet been selected. Since the only set that has not yet been selected at this point is the set with constraint b, the second selection unit 12 selects the set with constraint b. Then, in the next step S4, the second selection unit 12 selects each spin x₂₂, x₂₃, x₂₄ that belongs to the set with constraint b and has not been added to the child problem, and adds each spin x₂₂, x₂₃, x₂₄ to the child problem.

In the above example, the case where the spin x₁₁ was selected in step S1 is used. It is assumed that, for example, that in step S1, the spin x₁₄ is selected and x₁₄ is added to the child problem, and then the process moves to step S3. In this case, the only set to which x₁₄ belongs and for which a constraint is defined is the set with constraint a. Constraint e and constraint f have higher priority than constraint a. However, at this point, not a single spin belonging to the set with constraint e or the set with constraint f has been added to the child problem. Therefore, in this case, the second selection unit 12 selects the set with constraint a. Then, in the next step S4, the second selection unit 12 selects each spin x₁₁, x₁₂, x₁₃ that belongs to the set with constraint a and has not been added to the child problem, and adds each of those spins x₁₁, x₁₂, x₁₃ to the child problem.

In the aforementioned example embodiment, the case in which the second selection unit 12 repeats the loop process of steps S3 to S6 is shown (see FIG. 2). However, in the configuration where the second selection unit 12 repeats the loop process of steps S3 to S6, there is a possibility that all spins in the combinatorial optimization problem are selected as a child problem, depending on how the sets with a constraint are defined for the combinatorial optimization problem. FIG. 4 is a schematic diagram showing an example of sets of spins with a defined constraint. In the example shown in FIG. 4, the total number of spins is 16. The set of spins for which a constraint is defined is shown with a frame around it. For example, a constraint is defined for the set of spins x₁₁, x₁₂, x₁₃, and x₁₄. Also, for example, a constraint is defined for the set of spins x₁₁, x₂₁, x₃₁, and x₄₁. For example, in the traveling salesman problem, as illustrated in FIG. 4, sets of spins are defined and the first constraint (the one-hot constraint) is defined for each set.

When the sets of spins are defined as illustrated in FIG. 4, the second selection unit 12 will select all spins in the combinatorial optimization problem as a child problem if the size of the child problem does not exceed the threshold in the configuration where the loop process of steps S3 to S6 is repeated.

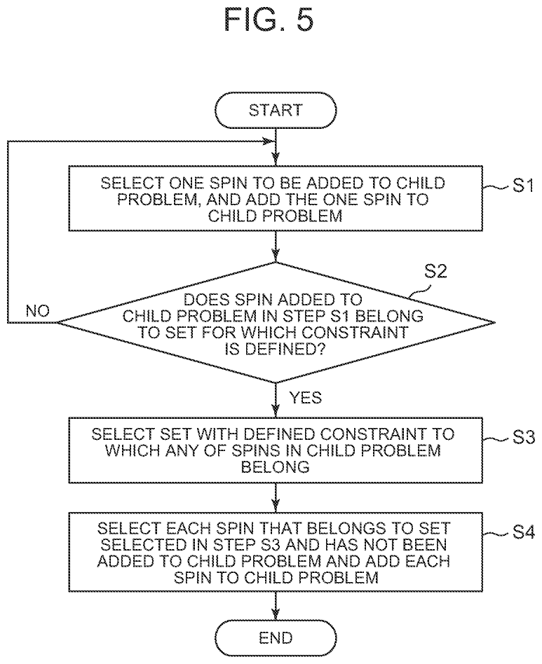

To prevent selecting all spins in the combinatorial optimization problem as a child problem, the second selection unit 12 may be configured to terminate the process when steps S3 and S4 shown in FIG. 2 are executed once each. FIG. 5 is a flowchart for this case. In FIG. 5, processes identical to those shown in FIG. 2 are marked with the same symbols as in FIG. 2, and explanations are omitted. As shown in FIG. 5, the process may be terminated when the second selection unit 12 executes steps S3 and S4 once each.

In this variation, step S3 is performed only once, so only one set is selected for which a constraint is defined. The process ends when the second selection unit 12 selects each spin that belongs to the set and has not been added to the child problem, and adds each spin to the child problem.

Therefore, even if multiple sets with a defined constraint are set as shown in FIG. 4, not all spins in the combinatorial optimization problem are selected as a child problem.

In addition, all spins belonging to only one selected set with a defined constraint are included in the child problem. Therefore, it is possible to generate a child problem in such a way as to prevent as much as possible the narrowing of the search range for the solution of the child problem.

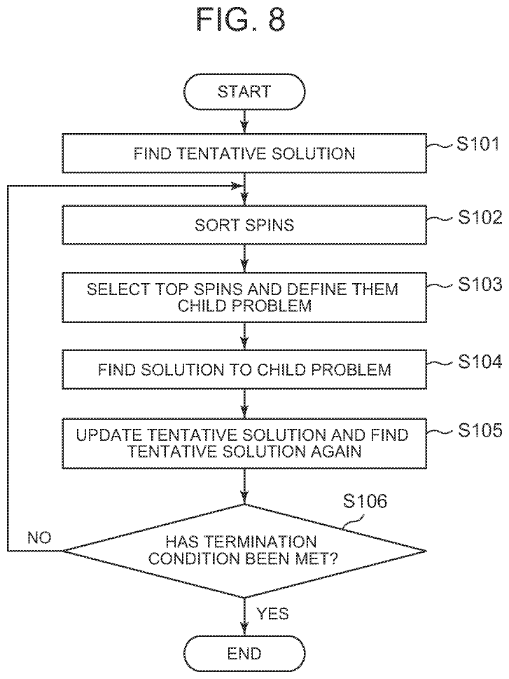

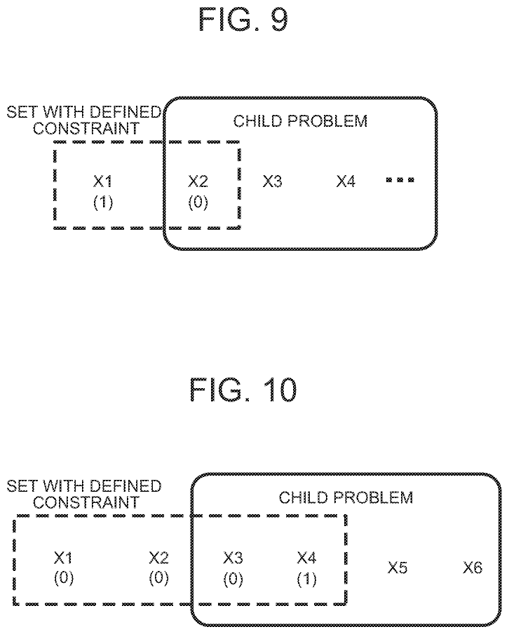

The child problem generation device 10 shown in the aforementioned example embodiment and each of the above variations may be applied, for example, to the method of solving combinatorial optimization problems described in NPL 2 (see FIG. 8), but the scope of application of the present invention is not limited to the solving method described in NPL 2. In other words, the child problem generation device 10 shown in the aforementioned example embodiment and in each of the above variations may be applied to other solving methods.

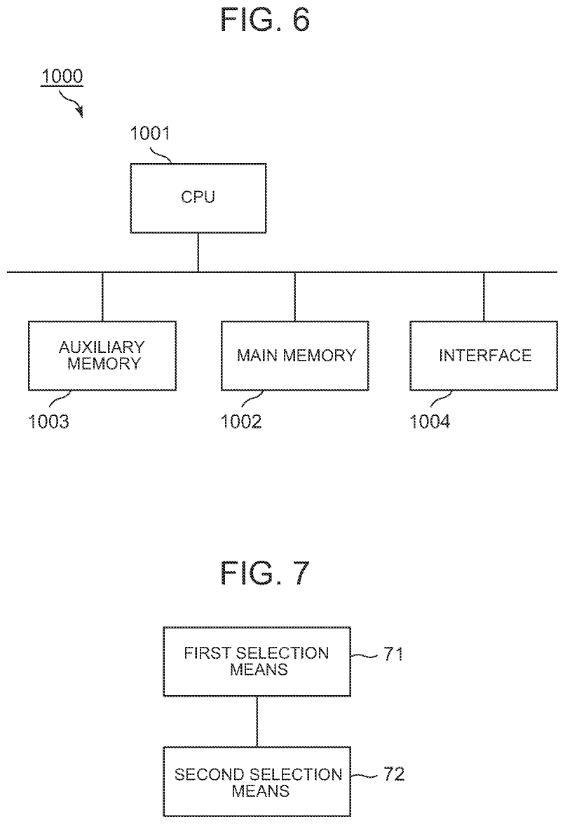

FIG. 6 is a schematic block diagram showing an example of a computer configuration of the child problem generation device of the example embodiment or variations thereof of the present invention. The computer 1000 includes a CPU 1001, a main memory 1002, an auxiliary memory 1003, and an interface 1004.

The child problem generation device 10 of the example embodiment or variations thereof of the present invention is realized, for example, by a computer 1000. The operation of the child problem generation device 10 is stored in the auxiliary memory 1003 in the form of a child problem generation program. The CPU 1001 reads the program, expands the program into the main memory 1002, and executes the processes described in the example embodiment or variations thereof of the present invention according to the program.

The auxiliary memory 1003 is an example of a non-transitory tangible medium. Other examples of non-transitory tangible media include magnetic disks connected via interface 1004, magneto-optical disks, CD-ROM (Compact Disk Read Only Memory), DVD-ROM (Digital Versatile Disk Read Only Memory), semiconductor memory, etc. When the program is delivered to the computer 1000 through a communication line, the computer 1000 receiving the delivery may expand the program into the main memory 1002 and execute the processes described in the above example embodiment according to the program.

Some or all of the components may be realized by general-purpose or dedicated circuitry, processor, or a combination of these. These may comprise a single chip or multiple chips connected via a bus. Some or all of the components may be realized by a combination of the above-mentioned circuitry, etc. and a program. When some or all of components are realized by multiple information processing devices, circuits, etc., the multiple information processing devices, circuits, etc. may be centrally located or distributed. For example, the information processing devices and circuits may be realized as a client-and-server system, a cloud computing system, etc., each of which is connected via a communication network.

The following is an overview of the present invention. FIG. 7 is a block diagram showing an overview of the child problem generation device of the present invention. The child problem generation device of the present invention includes first selection means 71 and second selection means 72.

The first selection means 71 (e.g., the first selection unit 11) selects one spin to be added to a child problem of a combinatorial optimization problem from each spin in the combinatorial optimization problem, and adds the one spin to the child problem.

When any of spins in the child problem belong to a set for which a constraint is defined, the second selection means 72 (e.g., the second selection unit 12) selects the set, selects each spin that belongs to the set and has not been added to the child problem, and adds each spin to the child problem.

According to such a configuration, it is possible to generate a child problem in such a way as to prevent as much as possible the narrowing of the search range for the solution of the child problem when constraints are defined on sets of spins.

The first selection means 71 may be configured to randomly selects the one spin. The first selection means 71 may be configured to select a spin whose amount of increase in energy function of the combinatorial optimization problem when a state of the spin is flipped is the largest, as the one spin.

The first selection means 71 may be configured to select a spin that belongs to a set for which a constraint is defined and for which the constraint is not satisfied, as the one spin.

It may be configured that priority of constraints is predetermined, and the first selection means 71 selects a spin that belongs to a set with a constraint with the highest priority defined, as the one spin.

It may be configured that priority of constraints is predetermined, and when there are multiple sets to which any of the spins in the child problem belong and for which a constraint is defined, the second selection means 72 selects a set with highest priority among the multiple sets, selects each spin that belongs to the set and has not been added to the child problem, and adding each spin to the child problem.

Although the present invention has been described above with reference to the example embodiment, the present invention is not limited to the above example embodiment. Various changes can be made to the configuration and details of the present invention that can be understood by those skilled in the art within the scope of the present invention.

### INDUSTRIAL APPLICABILITY

The present invention is suitably applied to a child problem generation device that generates a child problem of a combinatorial optimization problem.

### REFERENCE SIGNS LIST

10 Child problem generation device
11 First selection unit
12 Second selection unit

What is claimed is:

1. A child problem generation device comprising:
a memory configured to store instructions; and
a processor configured to execute the instructions to:
select one spin to be added to a child problem of a combinatorial optimization problem from each spin in the combinatorial optimization problem, and add the one spin to the child problem; and
when any of spins in the child problem belong to a set for which a constraint is defined, select the set, select each spin that belongs to the set and has not been added to the child problem, and add each spin to the child problem.

2. The child problem generation device according to claim 1,
wherein the processor randomly selects the one spin.

3. The child problem generation device according to claim 1,
wherein the processor selects a spin whose amount of increase in energy function of the combinatorial optimization problem when a state of the spin is flipped is the largest, as the one spin.

4. The child problem generation device according to claim 1,
wherein the processor selects a spin that belongs to a set for which a constraint is defined and for which the constraint is not satisfied, as the one spin.

5. The child problem generation device according to claim 1,
wherein priority of constraints is predetermined, and
wherein the processor selects a spin that belongs to a set with a constraint with the highest priority defined, as the one spin.

6. The child problem generation device according to claim 1,
wherein priority of constraints is predetermined, and
wherein, when there are multiple sets to which any of the spins in the child problem belong and for which a constraint is defined, the processor selects a set with highest priority among the multiple sets, selects each spin that belongs to the set and has not been added to the child problem, and adding each spin to the child problem.

7. A child problem generation method, implemented by a computer, comprising:
selecting one spin to be added to a child problem of a combinatorial optimization problem from each spin in the combinatorial optimization problem, and adding the one spin to the child problem; and
when any of spins in the child problem belong to a set for which a constraint is defined, selecting the set, selecting each spin that belongs to the set and has not been added to the child problem, and adding each spin to the child problem.

8. A non-transitory computer-readable recording medium in which a child problem generation program is recorded, wherein the child problem generation program causes a computer to execute:
a first selection process of selecting one spin to be added to a child problem of a combinatorial optimization problem from each spin in the combinatorial optimization problem, and adding the one spin to the child problem; and
a second selection process of, when any of spins in the child problem belong to a set for which a constraint is defined, selecting the set, selecting each spin that belongs to the set and has not been added to the child problem, and adding each spin to the child problem.
